(19) United States
(12) Patent Application Publication
(10) Pub. No.: US 2016/0048989 A1
(43) Pub. Date: Feb. 18, 2016

(54) METHOD FOR MANAGING MEDIA ASSOCIATED WITH A USER STATUS

(71) Applicant: Mark Anthony Gabbidon, Johnson City, NY (US)

(72) Inventor: Mark Anthony Gabbidon, Johnson City, NY (US)

(21) Appl. No.: 14/827,327

(22) Filed: Aug. 16, 2015

Related U.S. Application Data
(60) Provisional application No. 62/038,338, filed on Aug. 17, 2014.
(60) Provisional application No. 62/068,731, filed on Oct. 26, 2014.

(51) Int. Cl. G06T 11/60; G06F 17/30; H04L 29/08; G06F 3/0481; G06F 3/0482; G06F 3/0484

(52) U.S. Cl. CPC G06T 11/60; G06F 3/0482; G06F 3/04842; H04L 67/10; G06F 3/0481; G06F 17/30058; G06T 2200/24

(57) ABSTRACT

A method for managing media associated with a user status through a device, the method being executed by processors configured by a media communication controller installed in the device to provide a status drawer having a plurality of selectable status information on a graphical user interface, to display media acquired by the device on windows provided inside the status drawer, to detect selection of a status information from said plurality of selectable status information, to collect the displayed media locally on the device or on a server over a network, to associate the collected media with the selected status information, create a media composition comprising said associated media and to share the status information and the media composition by a first user with other users.

### CROSS-REFERENCE TO RELATED APPLICATIONS

This Non-Provisional Utility patent application claims the benefit of the filing date of U.S. Provisional Patent Application No. 62/038,338 filed 17 Aug. 2014 titled “Method for implementing a status drawer.” and of U.S. Provisional Patent Application No. 62/068,731 filed 26 Oct. 2014 titled “Method for sharing, storing and organizing media” which are herein incorporated by reference.

### COPYRIGHT NOTICE

A portion of the disclosure of this specification contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD OF THE INVENTION

The present invention relates to the field of information management corresponding to an activity or interest of a person. More particularly, the present invention relates to a system and method for managing, organizing and sharing of status information and any media associated with the status information of a user.

### BACKGROUND OF THE INVENTION

The following background information may present examples of specific aspects of the prior and existing solutions (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many online technologies exist that allow users to group, organize and store media captured such as videos and pictures by uploading media to online account created for the user. However, these methods used at present involve a more cumbersome and inefficient process as a user must first locate and select the multiplicity of media captured which may be stored on several devices belonging to the user, before uploading the media to the online account. Also, the prior art technologies do not allow the users to associate any media such as video, image, audio etc. being captured through one or more devices with a particular status of a user and to store, organize and share the captured/acquired media simultaneously in real time corresponding to a selected status information. Many times media captured by a device is lost when a device is lost or damaged before the user gets the chance to perform the upload of the media to the online account. Thus users may seek an option that effectively uploads the media as it is being captured to the online account.

The present day systems and methods do not allow users to easily organize and store, online or offline, a plurality of electronic video, audio or image files related to a single activity or a status of a user which are acquired intermittently over a period of time. The present day systems and methods also do not allow sharing of a plurality of acquired media that are associated with a status of a user and organized in a user friendly manner with other users in real time or in at anytime later. The prior art methods and systems also do not facilitate easy identification of a current status related to a user as the status information mostly contains textual information only. Thus, users may seek an option that allows them to automatically upload and store media such as but not limited to pictures, videos and audio on an online location in an intuitively organized fashion.

Thus, there exists a need for a system and method for enabling a user to conveniently associate one or more media files related to an activity captured through a device to a category of interest and to organize, store and share the same with other users.

### OBJECTS OF THE INVENTION

It is, therefore, an object of the present invention is to provide a digital status drawer having a plurality of preloaded or user defined items/status information to enable a user to select a status/item that suits an activity or interest/place/things etc. of the user for communicating the status information to one or more other users.

Another object of the present invention is to provide a system and method associating one or more forms of media captured through a device to a status or interest of a user selected from a status drawer.

Yet another object of the present invention is to provide a system and method for storing and organizing, locally in a client device and/or remotely in a central data store, one or more media under a desired status category to which the media is associated with.

Still another object of the present invention is to provide a system and method for conveniently communicating status information by a user to one or more other users in terms of one or more forms of media associated with the status over a network.

A further object of the present invention is to provide a system and method for enabling plurality of users to associate, store, organize and share one or more electronic media files corresponding to a particular status or interest of any of the users.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention relates to a system and method for selecting a status information of a user on a device such as smartphones, tabs, laptops, desktops etc. and then associating one or more media files such as audio files, video files, image files, text files etc. acquired through the computing device with the selected status information. The system and method of the present invention further enables storing and organizing of the associated media online on a server and/or locally on the device itself. The selected status information and the media associated, stored and organized corresponding to the selected status information can be shared with other users in real time and/or at any time later over a network. The present invention provides a status drawer comprising a plurality of selectable predefined or user defined status information on the user interface of the device on which the software application of the present invention, namely media communication controller, is installed and run. The graphical user interface of the status drawer provided by the present invention includes media windows for displaying the media acquired such as video captured by the camera of the device and/or media downloaded and played on the device. A user can easily select a status information from the status drawer relevant to the status, activity or place of interest etc. and associate the media displayed in the media windows of the status drawer with the selected status information.

The media communication controller provides a number of options to the user through the status drawer for grouping/organizing the one or more media acquired and associated with a selected status information. One of the options is to simply select a status information from the status drawer and set a timeframe. The media communication controller would start collecting the media acquired by the device and associate, store and organize the collected media composition corresponding to the selected status information. The other options can be to organize the acquired media corresponding to a selected status in an album mode or in a journal mode. If a user selects the album option from the status drawer, after selecting a status information, and sets a timeframe, then the media communication controller would keep on collecting, associating, storing the acquired media composition till the time the timeframe expires or the selected status is manually deactivated. The first user using the device with the media communication controller installed can share the selected status information and the associated media over a network with other registered users of the system of the present invention in real time while the media acquisition is occurring and also when the collected, stored media is organized as an album. If the journal option is selected by the user from the status drawer then the media communication controller keeps on collecting the media whenever a media acquisition occurs irrespective of intermediate pause or stoppage in media acquisition till the timeframe expires or the status is manually deactivated. The collected and stored media associated with the selected status is then organized as a journal, preferably showing the date and time of acquisition which can be shared with other registered users. In some embodiments, a user can let the media communication controller run in the background of a device and, in that case, whenever the device acquires a media, the status drawer prompts the user to inform that a status can be selected for associating the acquired media with the status. In some embodiments, the selectable status information is provided with individual media window icon along with the description of the status which may include a piece of media acquired by the device and associated with the selected status.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a block diagram of the various components of a device in accordance with an embodiment of the present invention;

FIG. 2 illustrates a block diagram depicting an exemplary client-server system which may be used by an exemplary web-enabled/networked embodiment of the present invention;

FIG. 3 illustrates a block diagram depicting a conventional client/server communication system which may be used by the present invention;

FIG. 4 illustrates a non-limiting exemplary screenshot of Graphical User Interface (GUI) provided by the present invention for selecting item/status information of interest/relevance and associating a media with the selected item/status information;

FIG. 5 illustrates exemplary selectable item/status information along with other features/control options on GUI in accordance with an embodiment of the present invention;

FIG. 6 illustrates two devices in communication with each other over a network for sharing of status information and associated media in accordance with an embodiment of the present invention;

FIG. 7 illustrates an exemplary screenshot of GUI on a device showing different media composition options with selectable item/status information in accordance with an embodiment of the present invention;

FIG. 8 illustrates an exemplary screenshot of GUI showing an album media composition in accordance with an embodiment of the present invention;

FIG. 9 illustrates an exemplary screenshot of GUI showing a journal media composition in accordance with an embodiment of the present invention;

FIG. 10 illustrates an exemplary system for creating a shared media composition on a cloud server by multiple users using multiple devices in accordance with an embodiment of the present invention;

FIG. 11 illustrates an exemplary screenshot of GUI showing categorization of media composition on a server for sharing by multiple of users in accordance with an embodiment of the present invention;

FIG. 12 is a flow diagram illustrating a method for managing media associated with a user status in accordance with an embodiment of the present invention;

FIG. 13 is a flow diagram illustrating further steps of the method for managing media associated with a user information depicted in FIG. 12 in accordance with an embodiment of the present invention.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures/computer architectures described herein are to be understood also to refer to functional equivalents of such structures. The present invention will now be described in detail with reference to embodiments thereof as illustrated in the accompanying drawings.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; a smartphone, a laptop, a game consoles, a Desktop Computer, application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed; (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, Firefox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Some embodiments of the present invention may provide means and/or methods for detecting and/or processing of data. Some of these embodiments may provide computer software for integration with electronic devices, including, without limitation, smartphones, tablets, laptops, game consoles, Desktop Computers, Electronic Music Keyboards, Smart TV(s), etc. In some embodiments, embodiment software may be suitable for use with various platforms, including, without limitation, IOS, Android, and Windows Desktop, Linux, Windows Server, etc. In one or more embodiments, embodiment software may be similar or identical for various platforms. In a non-limiting example, embodiment software may be functional on both a smartphone and a tablet.

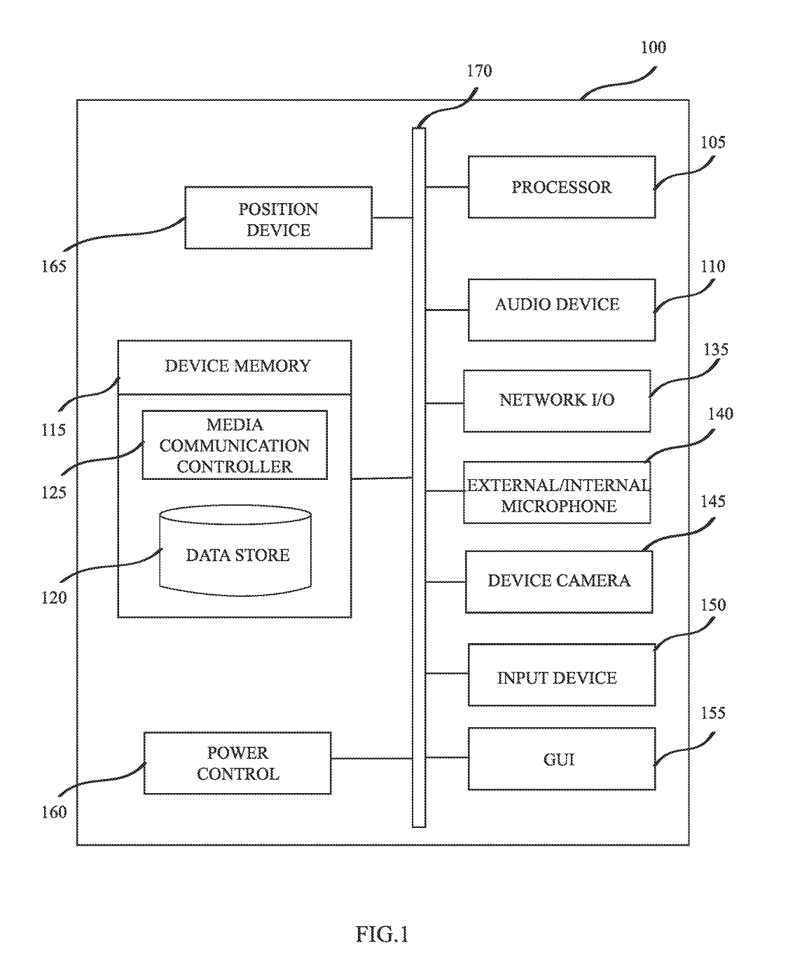

FIG. 1 is an illustration of exemplary components of a computer 100 for detecting and/or processing data, in accordance with an embodiment of the present invention. Hereinafter, computer 100 is alternatively and interchangeably referred to as device 100. In the present embodiment, the device 100 comprises a processor 105, an audio device 110, a device network I/O 135, a media acquisition device such as a camera 145 and an external/internal microphone 140, an input device such as a keyboard 150, a display to present GUI 155, a power control 160, a position device 165, a device memory 115 and a data store 120 etc. The device network I/O 135 may enable communication between one or more devices. In a non-limiting, a device network I/O 135 may enable communication between a device 100, a server application, and one or more devices in a network. In another non-limiting example, a device network I/O 135 may enable communication between one or more devices on the same network such as but not limited to a local access network or devices connected by Wi-Fi or Bluetooth. In a non-limiting example communication may be audio, video, textual data or instructional data transferred over the network such as is necessary for video or picture text, text messaging, sending user status updates, live video chat, syncing devices, executing instructions, etc. In the present embodiment, device 100 may use media acquisition devices such as the internal and/or external microphone 140, camera 145, and/or input device 150 to support communication between devices. In a non-limiting example, a microphone 140, a video camera 145, and a keyboard may support audio and/or visual communication between device 100, a server application, and/or one or more devices in a network. In the present embodiment, device 100 may use a GUI 155 to detect visual media. Processor 105 may be comprised of a single processor or multiple processors. Processor 105 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. The aforementioned components of device 100 may communicate in a unidirectional manner or a bi-directional manner with each other via a communication channel 170. Communication channel 170 may be configured as a single communication channel or a multiplicity of communication channels.

Reference to FIG. 1, the media communication controller 125 is an application, or “app” or a portion of an application which is a computer program or software that may be downloaded and operably installed in client device 100 using methods known in the art. In the present embodiment, the media communication controller 125 is operably installed in the device memory 115.

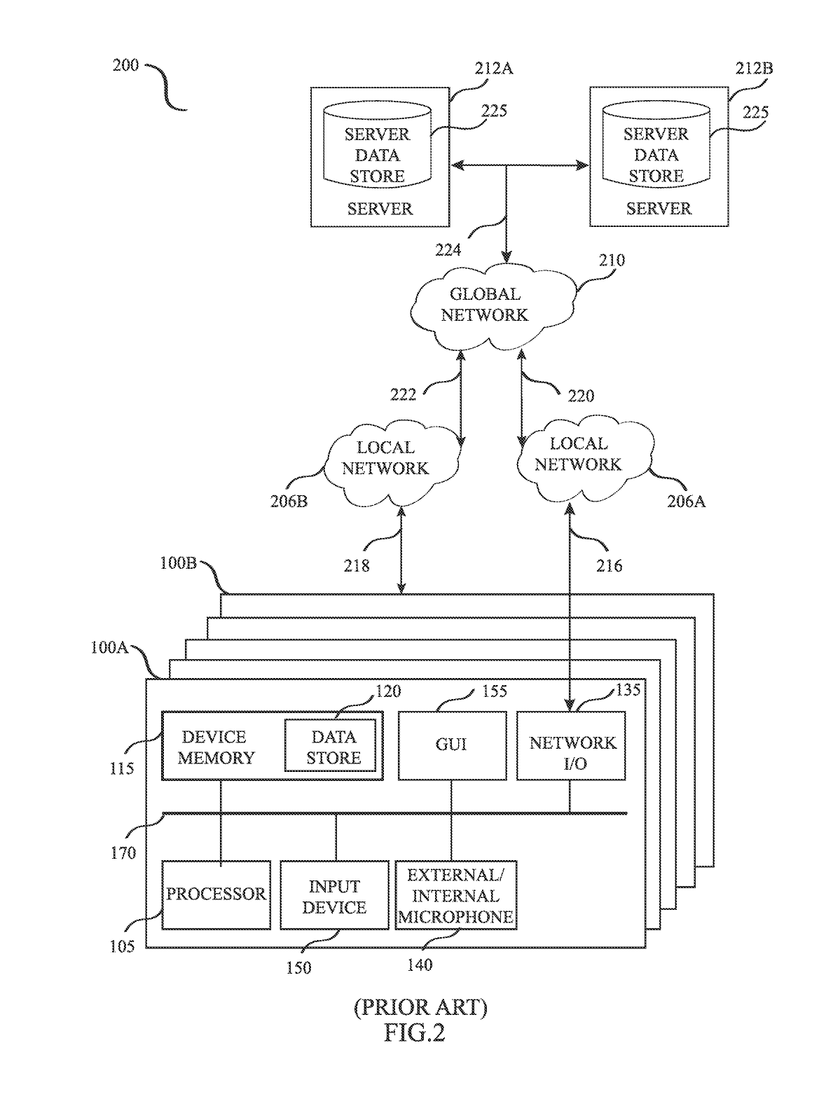

FIG. 2 is a block diagram depicting an exemplary client/server system which may be used by an exemplary web-enabled/networked embodiment of the present invention.

A communication system 200 includes a multiplicity of devices 100 as clients with a sampling of devices denoted as a client 100A and a client 100B, a multiplicity of local networks with a sampling of networks denoted as a local network 206A and a local network 206B, a global network 210 and a multiplicity of servers with a sampling of servers denoted as a server 212A and a server 212B.

Client 100A may communicate bi-directionally with local network 206A via a communication channel 216. Client 100B may communicate bi-directionally with local network 206B via a communication channel 218. Local network 206A may communicate bi-directionally with global network 210 via a communication channel 220. Local network 206B may communicate bi-directionally with global network 210 via a communication channel 222. Global network 210 may communicate bi-directionally with server 212A and server 212B via a communication channel 224. Server 212A and server 212B may communicate bi-directionally with each other via communication channel 224. Furthermore, clients 100A, 100B, local networks 206A, 206B, global network 210 and servers 212A, 212B may each communicate bi-directionally with each other.

In one embodiment, global network 210 may operate as the Internet. It will be understood by those skilled in the art that communication system 200 may take many different forms. Non-limiting examples of forms for communication system 200 include local area networks (LANs), wide area networks (WANs), wired telephone networks, wireless networks, or any other network supporting data communication between respective entities.

Devices or Clients 100A and 100B may take many different forms. Non-limiting examples of clients 100A and 100B include personal computers, personal digital assistants (PDAs), cellular phones and smartphones.

As is well known in the art, device memory 115 is used typically to transfer data and instructions to processor 105 in a bi-directional manner. Device memory 115, as discussed previously, may include any suitable computer-readable media, intended for data storage, such as those described above excluding any wired or wireless transmissions unless specifically noted. Mass memory storage or data store 120 may also be coupled bi-directionally to processor 105 and provides additional data storage capacity and may include any of the computer-readable media described above. Mass memory storage 120 may be used to store programs, data and the like and is typically a secondary storage medium such as a hard disk. It will be appreciated that the information retained within mass memory storage 120, may, in appropriate cases, be incorporated in standard fashion as part of device memory 115 as virtual memory.

Processor 105 may be coupled to GUI 155. GUI 155 enables a user to view the operation of computer operating system and software. Processor 105 may be coupled to an input device 150 which can include a pointing device and keyboard. Non-limiting examples of pointing device include computer mouse, trackball and touchpad. Pointing device enables a user with the capability to manoeuvre a computer cursor about the viewing area of GUI 155 and select areas or features in the viewing area of GUI 155. Keyboard enables a user with the capability to input alphanumeric textual information to processor 105. Processor 105 may be coupled to an external/internal 140. External/internal microphone 140 enables audio produced by a user and/or surroundings to be recorded, processed and communicated by processor 105. Processor 105 may be connected to a camera 145. Camera 145 enables video/image produced or captured by user to be recorded, processed and communicated by processor 105.

Finally, processor 105 optionally may be coupled to network I/O interface 135 which enables communication with an external device such as a database or a computer or telecommunications or internet network using an external connection shown generally as communication channel 216, which may be implemented as a hardwired or wireless communications link using suitable conventional technologies. With such a connection, processor 105 might receive information from the network, or might output information to a network in the course of performing the method steps described in the teachings of the present invention.

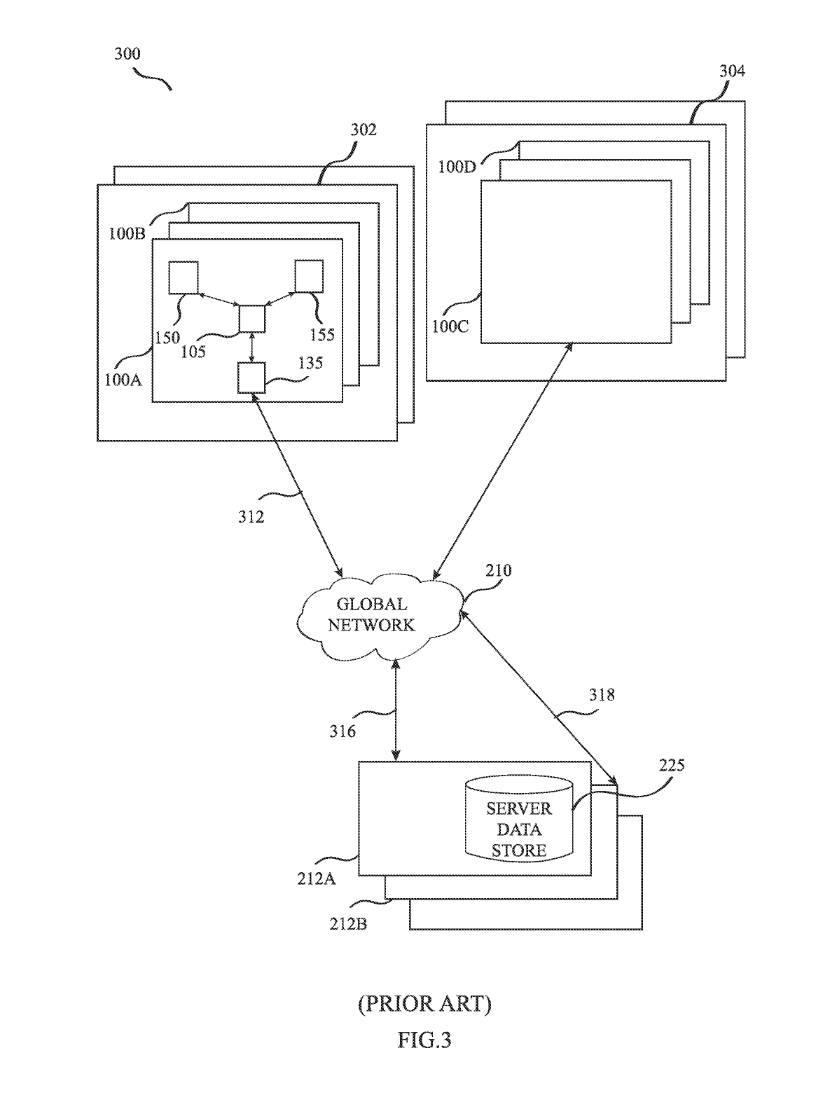

FIG. 3 illustrates a block diagram depicting a conventional client/server communication system.

A communication system 300 includes a multiplicity of networked regions with a sampling of regions denoted as a network region 302 and a network region 304, a global network 210 and a multiplicity of servers with a sampling of servers denoted as a server device 4308 and a server device 212B.

Network region 302 and network region 304 may operate to represent a network contained within a geographical area or region. Non-limiting examples of representations for the geographical areas for the networked regions may include postal zip codes, telephone area codes, states, counties, cities and countries. Elements within network region 302 and 304 may operate to communicate with external elements within other networked regions or within elements contained within the same network region.

In some implementations, global network 210 may operate as the Internet. It will be understood by those skilled in the art that communication system 300 may take many different forms. Non-limiting examples of forms for communication system 300 include local area networks (LANs), wide area networks (WANs), wired telephone networks, cellular telephone networks or any other network supporting data communication between respective entities via hardwired or wireless communication networks. Global network 210 may operate to transfer information between the various networked elements.

Server device 212A and server device 212B may operate to execute software instructions, store information, support database operations and communicate with other networked elements. Non-limiting examples of software and scripting languages which may be executed on server device 212A and server device 212B include C, C++, C# and Java.

Network region 302 may operate to communicate bi-directionally with global network 210 via a communication channel 312. Network region 304 may operate to communicate bi-directionally with global network 210 via a communication channel 314. Server device 212A may operate to communicate bi-directionally with global network 210 via a communication channel 316. Server device 212B may operate to communicate bi-directionally with global network 210 via a communication channel 318. Network region 302 and 304, global network 210 and server devices 212A and 212B may operate to communicate with each other and with every other networked device located within communication system 300.

Server devices, such as 212A and 212B, include server data store 325 and may operate to communicate bi-directionally with global network 210 via communication channel 316.

Network region 302 includes a multiplicity of clients with a sampling denoted as a client 100A and a client 100B. Network I/O 135 may communicate bi-directionally with global network 210 via communication channel 312 and with processor 105. GUI 155 may receive information from processor 105 for presentation to a user for viewing. Network region 304 includes a multiplicity of clients with a sampling denoted as a client 100C and a client 100D.

For example, consider the case where a user interfacing with client 100A may want to execute a networked application. A user may enter the IP (Internet Protocol) address for the networked application using input device 150. The IP address information may be communicated to processor 105. Processor 105 may then communicate the IP address information to networking device 135. Network I/O 135 may then communicate the IP address information to global network 210 via communication channel 312. Global network 210 may then communicate the IP address information to server 212A via communication channel 316. Server 212A may receive the IP address information and after processing the IP address information may communicate with the server data store 325 to fetch any information that may be required and then return information to global network 210 via communication channel 316. Global network 210 may communicate the return information to network I/O 135 via communication channel 312. Network I/O 135 may communicate the return information to processor 105. Processor 105 may communicate the return information to GUI 155 and user may then view the return information on GUI 155.

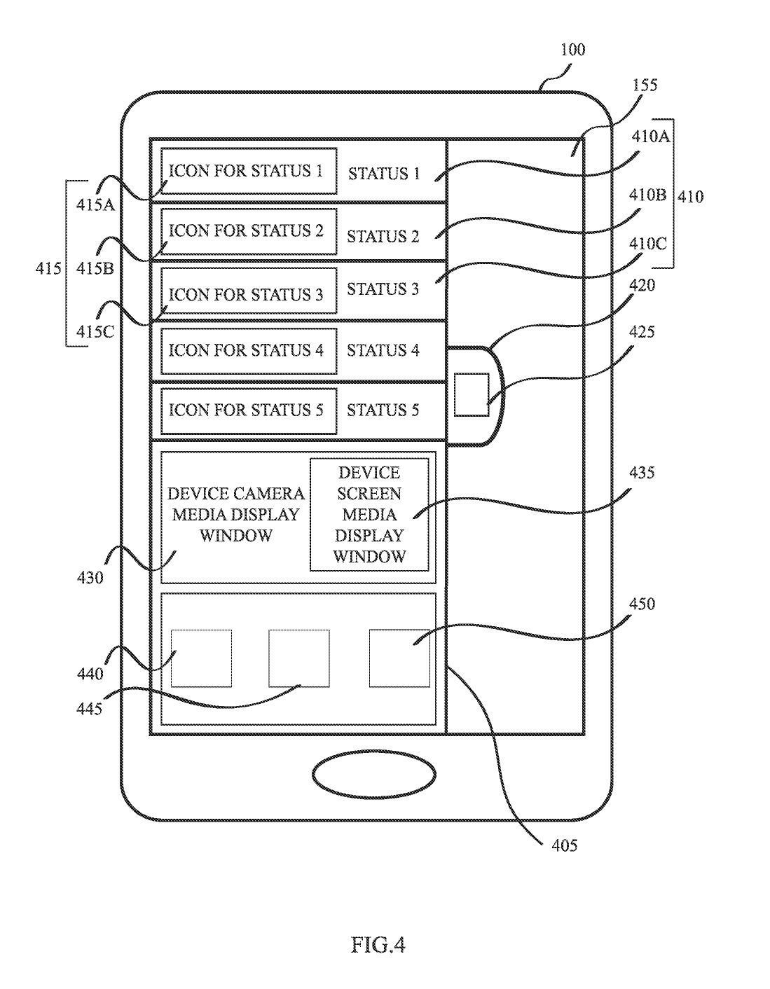

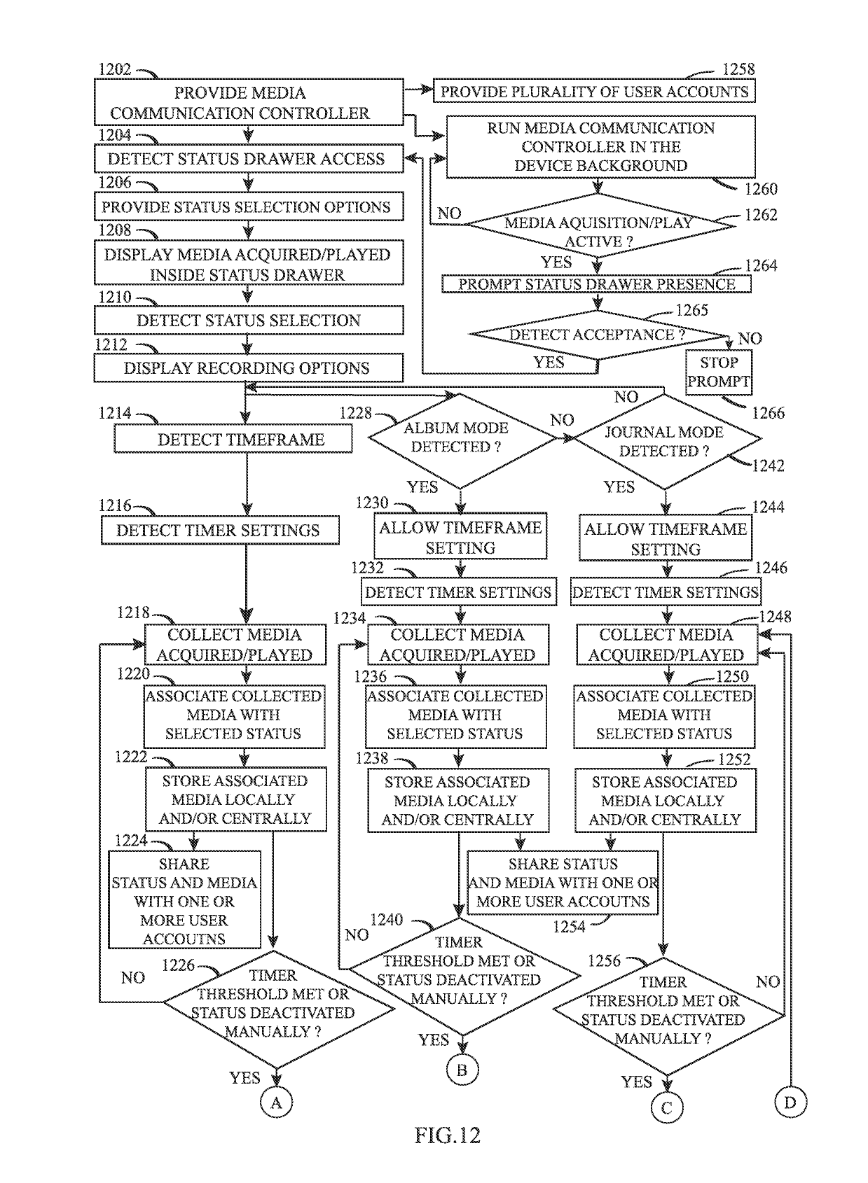

FIG. 4 illustrates a non-limiting exemplary screenshot of Graphical User Interface (GUI) 155 provided by the present invention on the display of device 100 for selecting item/status information 415 of relevance from a status drawer 405 and associating a media with the selected item/status information. For this, the media communication controller 125 provided by the present invention, as in step 1202 of FIG. 12, is installed on the device 100. In a preferred embodiment, the media communication controller 125, through the GUI 155 presented on the display of device 100, enables one or more users to open account and get registered with system of the present invention as in step 1258 of FIG. 12. Hereinafter, the terms “drawer” and “status drawer” are interchangeably and alternatively used. The processor 105 executes one more instructions included in the media communication controller 125 stored in the device memory 115 to present the GUI 155 with status drawer 405, as in step 1206 of FIG. 12, on the GUI 155 once the media communication controller 125 detects access to the application, as in step 1204 of FIG. 12. In some embodiments, the GUI 155 can be presented by a client application such as a browser installed in the device 100 in communication with one or more servers hosting a web application/server application in accordance with an embodiment of the present invention. The status drawer 405 may include plurality of predefined or user defined status information 410 such as Status 1 (410A of FIG. 4), Status 2 (410B of FIG. 4), Status 3 (410C of FIG. 4), Status 4, Status 5 etc. that define the current activity that a user may be performing. In another embodiment, the status drawer 405 may consist of selectable items not related to user status such as that defines person, place, thing, event, time, item of interest, etc. The terms “status”, “status information” and “item” are used alternatively and interchangeably. In some embodiments of the present invention, each of status information 410 may include a media window icon 415 for displaying a media such as a video/image corresponding to the particular status information (e.g. media window icon 415A for status information 410A, 415B for 410B and 415C for 410C etc.). In some embodiments the status drawer 405 may first appear hidden and may be pulled out with a drawer handle 420, or even without a handle, from the side or top of the GUI 155 by performing a gesture such as but not limited to a swipe gesture from the edge of the GUI 155. The drawer handle 420 may include a visual alert 425. Examples of visual alert 425 include, but not limited to, an icon, an image, a textual instruction etc. In a non-limiting example, a user may have received a text message from another user, thus the media communication controller 125 may engage the status drawer 405 by initializing the drawer handle 425 so that it becomes visible to the user. In many embodiments the status drawer 405 may function inside an application associated with the status drawer 405 such as but not limited to a chat, media or social media application. In such cases the status drawer 405 may be accessible when the application is opened. In other embodiments, the drawer may function outside of an application associated or not associated with the drawer 405 such as to provide quick access to a service without the need to open the application. In one such embodiment the drawer 405 may be automatically initialized without the user opening the main application associated with drawer 405 such as but not limited to when the media communication controller 125 detects media running on the device 100. The media communication controller 125 may initialize the drawer 405 in order that the user may quickly perform some action related to the media detected such as but not limited to selecting a status related to the media detected.

In some embodiments, the status drawer 405 may provide a window 430, as in step 1208 of FIG. 12, to display the media acquired through the media acquisition device such as camera 145 of the device 100. The status drawer 405 may also include an additional window 435 to display the media played on the GUI 155. The media being played can be a media file downloaded to the device 100 or a screen capture of the device. One or more recording options or media capturing options are provided inside the status drawer 405 through control buttons 440, 445, 450 provided on the GUI 155.

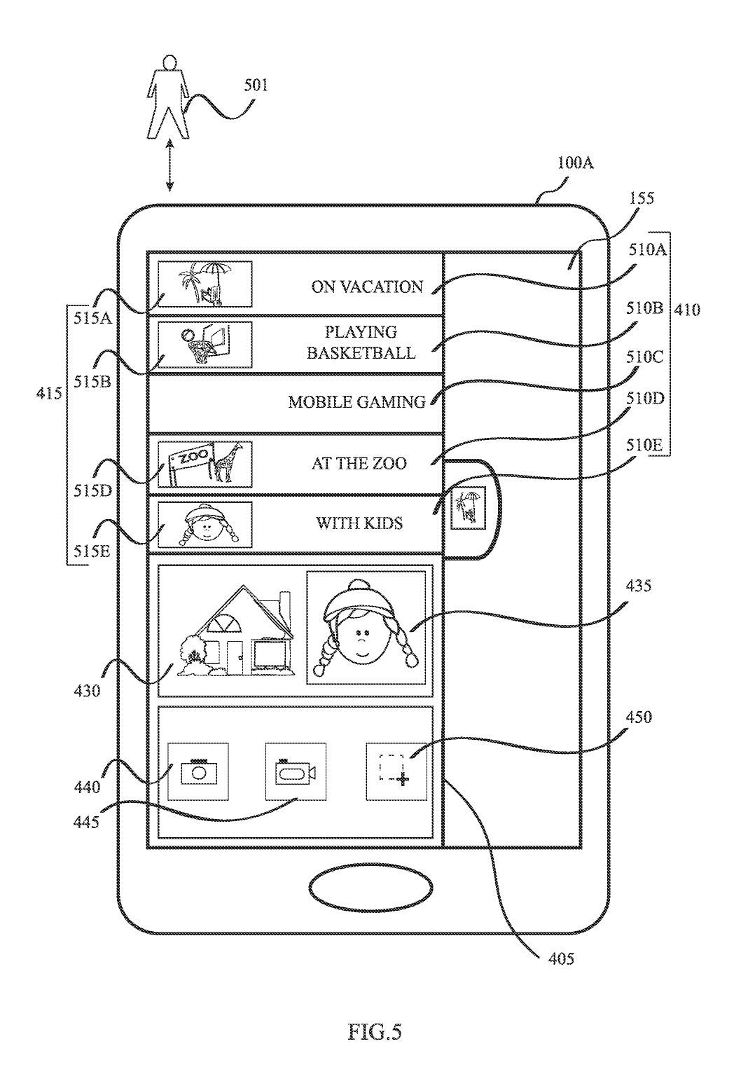

Reference to FIG. 1, FIG. 2, FIG. 3, FIG. 4 and FIG. 5, in a preferred embodiment, the media communication controller 125 installed on the device memory 115 of device 100 may engage the processor 105 to control various components of the device 100 related to detecting and processing media such as but not limited audio, video, image, text data, data embedded in an audio stream, data embedded in video stream, data embedded in a website or web based application any data associated with the media, data sent over a network, etc. In some embodiments, in a non-limiting example, the processor 105 may interface with other components of device 100 to process instructions related to appending one or more media such as videos or pictures to one or more status information 410 in the status drawer 405. For example, as shown in FIG. 5, a user 501, hereinafter referred to as first user 501, may select one or more status information 410 from status drawer 405 corresponding to her activity status or interest, place, event etc. at a given point of time and append one or more media files captured through or played on her device 100, hereinafter referred to as first user device 100A (e.g. on her smartphone 100A), corresponding to the selected status information for storing, organizing and sharing. In the present example, first user 501 may be on vacation and, thus, can select status information “On Vacation” 510A from the status drawer 405. Similarly, a user can select one or more other status information such as “Playing Basketball” 510B, “Mobile Gaming” 510C, “At the Zoo” 510D, “With Kids” 510E etc. relevant to her status. Once a status information, for example, “On Vacation” 510A, is selected by the first user 501, the media communication controller 125 would engage processor 105 of device 100 to associate any media captured through the camera 145 of the device 100 with the status information “On Vacation” 510A. The media captured through camera 145 is displayed in media window icon 515A. Similarly, on selection of one or more other status information such as “Playing Basketball” 510B, “At the Zoo” 510D, “With Kids” 510E, media window icons 515B, 515D and 515E will display media acquired through camera 145 corresponding to the selected status information/item.

Reference to FIG. 4 and FIG. 5, in one embodiment, once the status drawer 405 is opened, one or more windows such as 430 and 435 become visible inside the status drawer 405. The user 501 can select any of the status information 410 while viewing the media being acquired through the device camera (or simply referred to as camera) 145 on the window 430 and/or view the media being downloaded/streamed and played on the device 100 on the window 435. The user 501 can use the various control buttons such as 440, 445 and 450 etc. included in the status drawer 405 to easily associate the media being displayed on the windows 430 and/or 435 with any of the status information 410. This feature enables a user to select a status information, associate acquired media with the status information and manage media being acquired by the device; all from a single screen of the status drawer 405 as shown in FIG. 5. In another embodiment, the media communication controller 125 can instruct the processor 105 to interface the status drawer 405 with any third party application/software (for example any camera app) running in the device 100 for controlling the media acquisition functions. In both these embodiments, once a status information is selected by a user, the status drawer may be closed leaving the selected status information active. In this case, until a timeframe set for the selected active status information expires or till the selected status information gets deactivated manually by the user, any media acquired through the media acquisition device, whether through the media control buttons of the status drawer or through the third party application, or any media downloaded and played on the device, would get collected, associated, organized, stored and shared automatically as per the predetermined settings without the need of opening the status drawer every time the media acquisition occurs.

In a non-limiting example, the processor 105 may interface with the audio device 110 of the device 100 to manage background music related to viewing media composition corresponding to a status information selection. For example, against selection of status information “On Vacation” 510A, the media communication controller 125 may acquire, associate and play an audio in the background corresponding to the video/image/animation/text associated/appended with status information “On Vacation”.

In some embodiments, depending on a preferred configuration, the media communication controller 125 may run in the background of the device 100, as in step 1260 of FIG. 12, and engage processor 105 to detect use of device camera 145 and/or media being played on the device 100, whenever activated, as in step 1262 of FIG. 12, and manage media files acquired through the device camera 145. For example, if the first user 501 has already selected status information “On Vacation” 510A while on a vacation, depending on customization of media communication controller 125, then, whenever the first user 501 activates the device camera 145 of her smart phone 100A, the captured media gets associated with the status information “On Vacation” and the status handle 425, with or without visual alert 425, may become visible to inform the first user 501 that the application media communication controller 125 is in action. In some embodiments, on detection of activation of device camera 145, the media communication controller 125 may prompt presence of the status drawer to the user, as in step 1264 of FIG. 12. For example, the media communication controller 125 may auto start the status drawer 405 thus making the drawer handle 420 visible and alerting the user to the availability of the status drawer 405. Acceptance of the prompt regarding presence of status drawer, as in step 1265 of FIG. 12, will make the media communication controller 125 detect the status drawer access as in step 1204 and provide the user with the status drawer selection options as in step 1206 of FIG. 12. If a user does not accept the prompt, then the prompt, such as the pop-up drawer handle disappears, as in step 1266 of FIG. 12, after a certain time period. Popping up of drawer handle 420 with or without visual alert 425 will enable the user to select a status information 410 from a status drawer 405 or from an equivalent status selector mechanism. In a non-limiting example, a device camera 145 in use may signify that the user is performing an activity (such as a user at the zoo taking pictures) thus the status drawer may 405 be automatically activated when device camera 145 is detected and visual alert 425 sent to user in order that the user may select status information “At the Zoo” 510D from the status drawer 405.

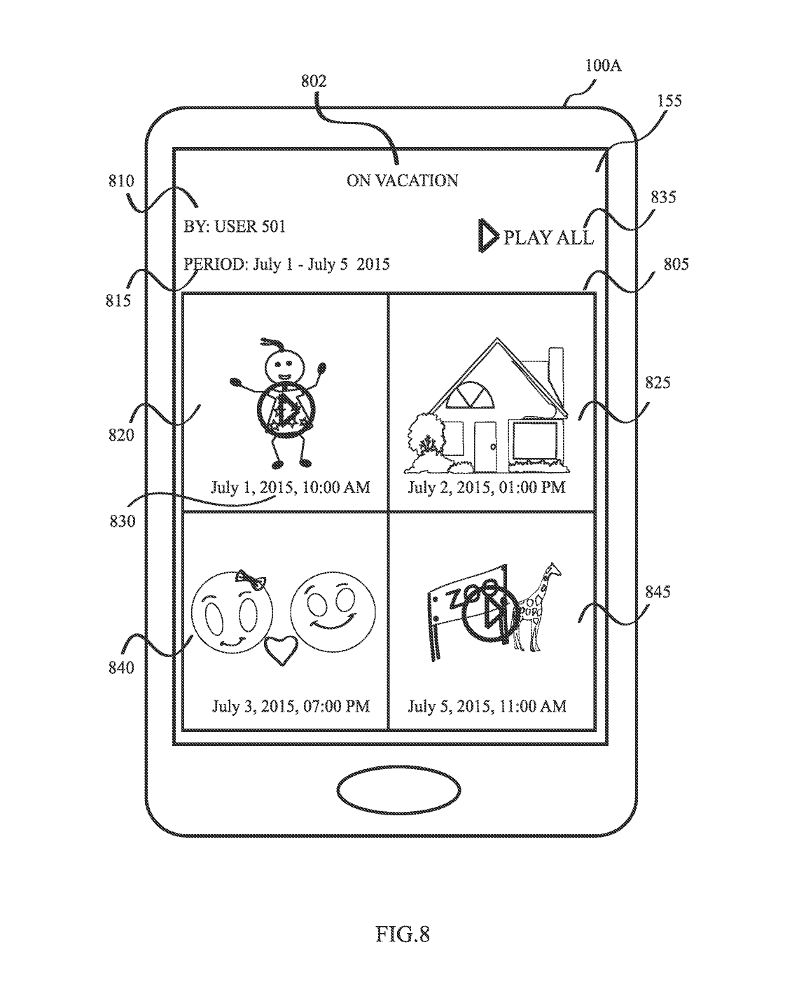

In some embodiments, media communication controller 125 may issue commands to upload media associated with a selected status information to a specified network based storage location such as a server 212A or 212B so that users may share media composition such as shown in example of FIG. 8 with other users over the network.

In the present embodiment, processor 105 may communicate with video camera to sample video data. In some embodiments, sampled video data may be stored for processing on device 100 memory components 120. In many embodiments, processor 105 may execute processing of video data in order to send or receive such data over a network to or from one or more recipients on a network or to a device such as server on the network. In another embodiment processor 105 may communicate with a media communication controller 125 to control various systems and operations on a computer device related to media processing. In another embodiment the processor may engage a native component of an operating system or the media controller in order to process media such as but not limited to recording video, taking photos, capturing device screen in picture or video format, displaying picture and managing audio and video on the device 100. Some non-limiting examples of media may include audio, image, video data from an audio stream, data embedded in a video stream or other data related to media being detected, data being streamed over a network, data embedded in a website, data embedded in a 3^{rd} party application running on the device, etc.

In another non-limiting example, the processor 105 may interface with other components of device 100 to send and receive status information 410 about one or more users over a network.

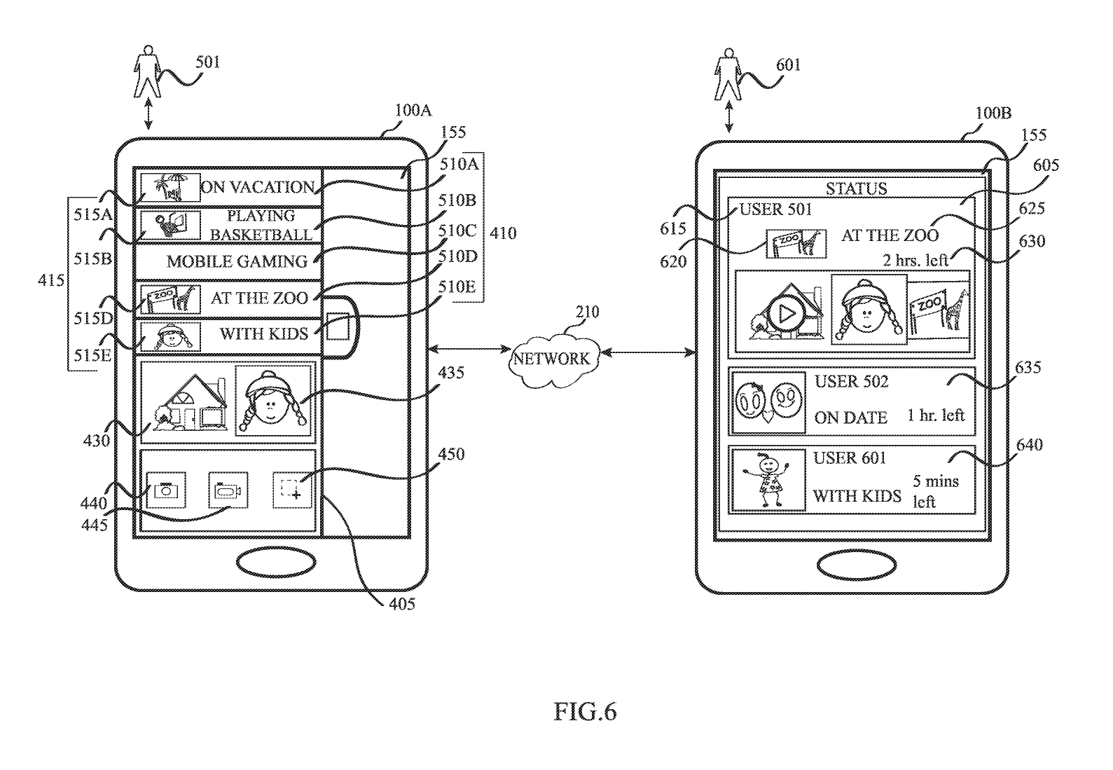

Reference to FIG. 1 through FIG. 6, media window icon 415 relating status information 410 may be implemented in order to more accurately communicate the user status to other users over a network. FIG. 6 illustrates two devices 100A and 100B (both conform to device 100 described in FIG. 1) in communication with each other through a network (or global network) 210. The present invention enables two or more users such as first user 501 and second user 601 to communicate, share and manage status information and the media associated with status information subject to request and approval of request by the interacting users. For example, first user 501 may be present at the zoo and thus selects a corresponding “At the zoo” status information 510D from status drawer 405 displayed on the GUI 155 of her device 100A. A media window icon such as 515D positioned next to the status information 510D may display video/image related to zoo type activities. In the same example, the first user 501 may send the status information 510D from her device 100A over the network 210 to the device 100B of second user 601. The processor 105 of the device 100B may execute one or more instructions received from the media communication controller 125 installed on the device 100B to present the status information and the media associated with the status information of one or more users as shown in the exemplary screen shot of the GUI 155 on the device 100B in FIG. 6. In the present example, status information “At the Zoo” 510D selected by the first user 501 along with the media window icon 515D are presented on the GUI 155 of device 100B as status information 625 and media window icon 620 respectively under the heading 615 for the status of the first user 501. In one embodiment the media window icon 515D or 620 may be a short video clip such as but not limited to 2 to 3 seconds' duration which may auto play continuously whenever the embodiment displaying the media window icon is visible to the user. To continue the embodiment, the name or identification of the user sending the status information may be viewable by the other receiving users as shown in FIG. 6. In another embodiment, on the same screen presented on the GUI 155, users may view their own status under a window 640 along with that of other users such as, for example, of user 502 under the window 635 in FIG. 6.

To continue the embodiment, media such as in 430 and 435 captured from device camera and/or resulting from device screen capture while the status information selection, such as but not limited to, 510D is active, may be grouped together and displayed along with status 625 for first user 501 in the device 100B of the second user 601 as shown in FIG. 6.

In one embodiment, the media window icons 415 may be pre-recorded or pre-produced and made selectable from a library of icons online (e.g. stored in server 212A or in server 212B) or local on the device 100 (e.g. in device memory 115) through the system 200 of the present invention. In addition, the selected media window icon 415 may be made assignable to a status information or item 410 from the status drawer 405 within the current invention for constant re-use.

Reference to FIG. 6, in another embodiment, the media window icon 415 can be a video capture of certain length, such as but not limited to, first few seconds of a video clip done with the device camera 145 while a status information 410 selection is on. In the same embodiment, video capture, such as resulting video 435 from device screen captures or 430 from device camera, may be performed and viewed from within the status drawer 405. The media window icon 415 may be automatically created from the video capture performed by the user and may be assigned to a user selected status information.

In one embodiment, when the device camera 145 and/or device screen capture mechanisms are engaged and resulting visual media is displayed as in windows 430 and 435, control mechanisms such as control buttons 440, 445, 450 used to capture video or picture may be at first made invisible or inaccessible and only becomes visible or accessible on the GUI 155 when the user selects a status information such as example 510D from the status drawer 405. Thus, by displaying the recordable control buttons only after a status information is selected, the media communication controller 125 may limit the association of a media window icon, for example icon 515D, to only the status information selected from the status drawer 405 and make it clear to the user that the item recorded is associated only with the selected status information (e.g. with status information 510D for media window icon 515D in the present example).

In another embodiment, the media window icon 415 may include any video imported over the network and be assigned to a status information. Examples of such video may include, but not limited to, recorded video, 3d animated videos, produced videos etc.

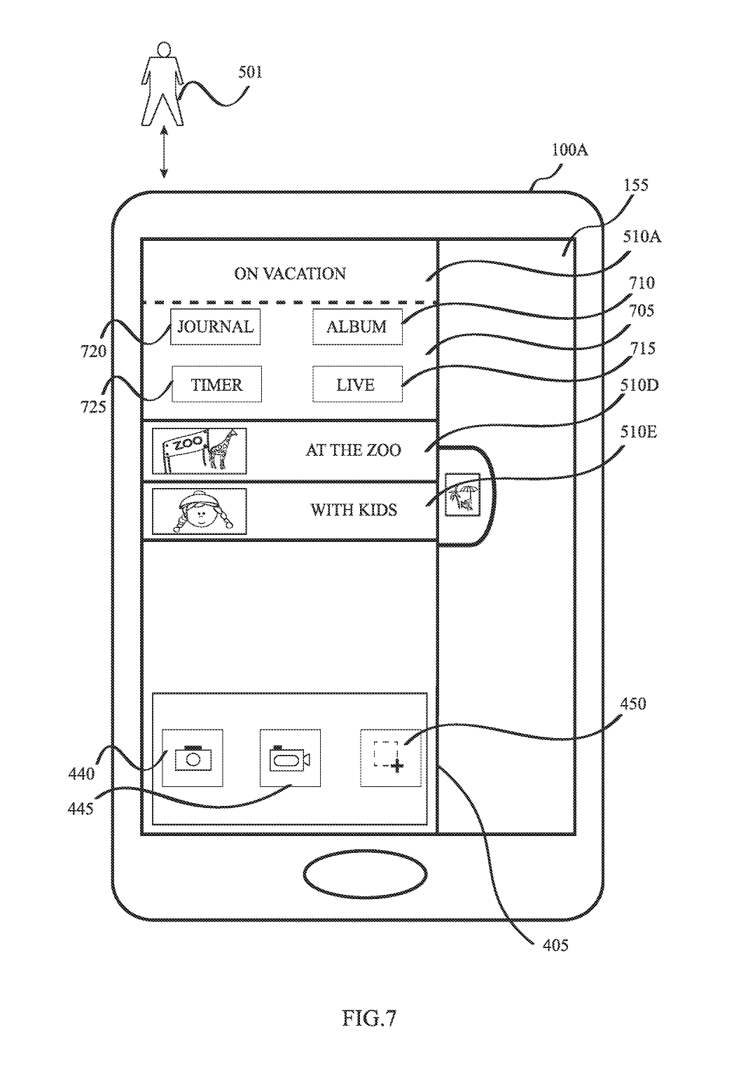

FIG. 7 illustrates an exemplary screen of GUI presented by the media communication controller 125 in collaboration with the other components of device 100 for setting different options to enable selection of a status information/item and associate/manage one or more media under the selected status information. Continuing with the present example, on detection of selection of the status information “On Vacation” 510A, as in step 1210 of FIG. 12, the status drawer 405 may expand to present one or more media capturing option buttons, as in step 1212 of FIG. 12. For example, buttons “Album” 710, “Live” 715, “Journal” 720 and “Timer” 725 etc. in a window 705 under the selected status information 510A.

In a preferred embodiment, the media recording options “Album” 710 and “Journal” 720 are two distinct features provided to the user on the status drawer. These two options allow a user to choose the type of media composition the user may wish to have with the media being collected and associated with any selected status information. Once a status selection is made, the status drawer allows the user to select any of these two options at any time thereafter. In one embodiment, the media communication controller 125 may start collecting, grouping and organizing media being captured as a result of album media composition button 710 being pressed and activated, as in step 1228 of FIG. 12, indicating a desire to start capturing, grouping and organizing the media and may end when the status is expired, no longer active, or deactivated by the user. In another embodiment, the grouping of media may commence once a status information/item in the status drawer 405 is selected, such as status 510A, and a timeframe, predetermined or user set, is detected by the media communication controller 125, as in step 1214 of FIG. 12, without activating album media composition button 710 or journal media composition button 720.

If neither “Album” 710 nor “Journal” 720 is selected then the media communication controller 125 issues instructions, as in step 1220 of FIG. 12, to the processor 105 to associate the media collected in step 1218 with the selected status once the timer setting is detected, as in step 1216 of FIG. 12, by the media communication controller 125. The collected and associated one or more media along with the status information may then be stored locally in the device 100A of the first user and/or remotely in server 212A and/or in server 1212B as in step 1222 of FIG. 12.

The status information and the associated media collected can be shared in live mode, or as per any timeframe set, with one or more other users using device 100 with media communication controller 125 installed over a network as in step 1224 of FIG. 12. In a preferred embodiment, the status information being shared, for example “At the Zoo” 625 shown in FIG. 6, also includes the media window icon 620 displayed along with the status information on the device 100B of the second user 601. The media window icon 620 may play a short media file from the media being acquired by the device 100A associated with the selected status information (“At the Zoo” 625 in the present example). In the same embodiment, reference to FIG. 6, for example as shown by reference numeral 630 in FIG. 6, the amount of time for which a status activity will remain active is detected by the media communication controller 125, as in step 1216 of FIG. 12. The timeframe may also be viewable by users (second user 601 in this example) over a network 210 can be set by the control button “Timer” 725. As shown in FIG. 6, multiple status information from a multiplicity of users may be viewable by users assigned or privileged through the present invention to receive the statuses such as but not limited example “Status Page” 605.

In another embodiment, the media communication controller 125 may engage processor 105 to automatically group captured media together while a status information selection is on. For example, while on vacation first user 501 may select “On Vacation” as her status information and keep it on. In this case, as long as the status information “On Vacation” remains selected, whenever the first user 501 uses her smart phone 100A to capture media files comprising video, still image, audio etc., continuously or intermittently, the processor 105 of device 100A would execute one or more instructions from media communication controller 125 to group all such captured media under the media composition 805 under the title “Vacation” 802 as shown in FIG. 8. Further, the media controller 125 may issue instructions to the processor 105 to associate the captured media composition with the status information selected by the user for as long the status is active. In one embodiment, once a status information such as “On Vacation” 510A is selected from a status drawer 405 as in FIG. 5, the media communication controller 125 may begin a media arrangement process over a timeframe as shown in FIG. 8. In the same embodiment, once a status information is selected, any media such as but not limited to text, audio, video, pictures, etc., captured from a device camera 145 or through an external device connected to the device 100 may be automatically stored, shared and arranged under the selected status information for a timeframe such as depicted in non-limiting example of FIG. 8.

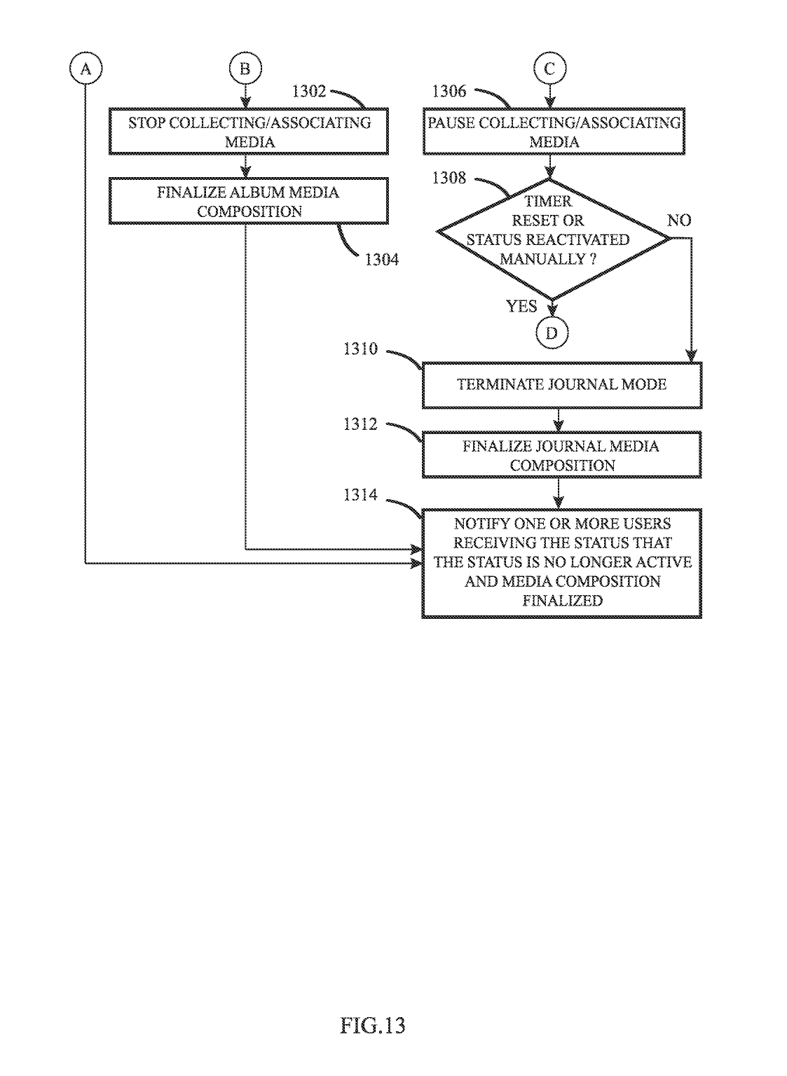

The following description may in non-limiting manner attempt to define how the timeframe may be implemented. In one embodiment, the timeframe may be a pre-determined period such as but not limited to 2 days, 1 year, 5 minutes, etc. pre-programmed into the media communication controller 125. To further describe the invention, once a status information such as 510A is set and becomes active, the pre-determine time period or timeframe hardcoded into the media communication controller 125 may instruct the processor 105 to begin a countdown process so that all media captured on the device 100 may be collected, shared and/or stored as well as arranged at a desired location during this process until such a time period has expired or the status/activity is terminated as in step 1226 of FIG. 12. Once the time period threshold is exceeded or the status information or activity terminated, the media composition may be organized showing the status information such as shown in exemplary screen of GUI 155 in FIG. 8 and one or more other users may be notified about the media composition as in step 1314 of FIG. 13.

The time frame may also be implemented by means of a timer mechanism such as control button “Timer” 725 as shown in FIG. 7 which allows the user to define the timeframe instead of the application i.e. the media communication controller 125 doing so, thus the same results may be achieved. The timer mechanism or control button “Timer” 725 may allow the user to input via the GUI 155 how long the activity, status or event may occur in minutes, hours, days, weeks, months, years, etc. Again, once timer threshold is met i.e. the timeframe ends, the media communication controller 125 may stop collecting captured media and finalize the media composition as shown in FIG. 8.

By way of example, to further explain the present invention, the status information 510A, when selected, may be expanded to show album media composition button “Album” 710 as shown in FIG. 7. In one embodiment, once the album media composition button 710 is selected by the user and a timeframe has been set, as in step 1230 of FIG. 12, the media communication controller 125 may run in the background of the device 100 and detect the timer settings as in step 1232 in FIG. 12. The media communication controller 125 may then configure the processor 105 and may begin collecting the media being captured by the device 100 such as photos and videos captured from device camera or device screen capture, text data, media downloaded to the device, etc., as in step 1234, of FIG. 12, while the selected status information is active as depicted in FIG. 8. The media being collected in step 1234 is then associated with the selected status (for example with status “On Vacation”) by the media communication controller 125 through the processor 105, as in step 1236 of FIG. 12. In one embodiment, collected media as shown in FIG. 8 may be uploaded to server (212A or 212B for example) or other device (device 100B, 100C etc. for example) on a network connected to the device 100. In another embodiment collected media may be stored and organized on the local device (for example, in the device memory 115). Yet in another embodiment, collected media maybe stored simultaneously both locally or on another device on the network such as a server or other device connected to the server or local device as in step 1238 of FIG. 12.

In one embodiment once a selected status information expires or is manually deactivated, media communication controller 125 detects it, as in step 1240 of FIG. 12, and may issue commands to the processor 105 to stop collecting and associating media as in step 1302 of FIG. 13. The media communication controller 125 then instructs the processor 125 to finalize the media composition as in step 1304 of FIG. 13 and send notification to user or other users over a network of the finalized media, etc. as in step 1314 of FIG. 13.

In one embodiment, the status information such as 510A may expire as a result of a hardcoded program time value such as 4 hrs. embedded in the media communication controller 125. In another embodiment the status information may expire as a result of a user input timer set by control button such as “Timer” 725 expiring. In another embodiment the status information may expire as a result of the user manually terminating the status.

In another embodiment the invention may make use of a device's position device 165 in order to identify places of interest such as but not limited to parks, theme parks, hotels, foreign locations, etc. To continue, once such places of interests are detected (for example place Zoo) by the position device 165, say for example by detecting the geo-coordinates of a location, the media communication controller 125 may automatically start collecting, storing, sharing over a network with other users and organizing media captured by the device 100A in a way similar to what has been shown in the exemplary screen 805 in FIG. 8 for as long as the device 100A is located at the place of interest (i.e. as long as, for example, user 501 stays at the Zoo). In some embodiments, the media communication controller 125 may first gain user permissions before performing the media collection process. Once the position device 165 detects that the device is no longer at the place of interest the media communication controller 125 may issue commands to the processor 105 to stop or pause collecting media and may finalize the media composition. The collected media may be grouped and arranged in chronological order such as in example shown in FIG. 8 with the name of place of interest as the title of composition or in any desired order.

In another embodiment, the media communication controller 125 may issue commands to the processor 105 to stop or pause collecting media once it has detected, via position device 165, the place of residence i.e. the geo-coordinates of the place of residence of the user which may signify that the user is no longer at the place of interest (for example at the Zoo) and has returned home. In such case, information (e.g. geo-coordinates) about the user's place of residence may be have been previously collected by or entered to the media communication controller 125.

In another embodiment, the media communication controller 125 may detect the user's home Wi-Fi identification and connection status as seen on the device 100 in order to identify when the user is at home vs away. In such an embodiment, the media communication controller 125 may have the user enter this information as a setup process in a prior step. Once the user selects a status information such as 510A “on vacation” related to an activity away from the home and leaves the home, the media communication controller 125 may automatically expire or terminate the status information “On Vacation” when the device 100 detects that the it is again connected to the home network which may signify that the user has returned home and is thus no longer performing status information such as example “on vacation” 510A.

In one embodiment, the media communication controller 125 may make use of a multiplicity of preloaded status related to away from home activities such as “On Vacation”, “At School”, “At Work”, etc., and may only utilize this Wi-Fi identification system to activate/expire such status. In another embodiment the media communication controller 125 may have the user identify the status information or item as an away from home activity during a setup or editing process.

In a non-limiting example, first user 501 may be on vacation for 4 days and may desire to collect and store and automatically organize media from this event as well as share the captured media with other users online as the activity commences. Using the application of the current invention on a smart phone, the user may select an item such as for example an “On vacation” status information 501A which may expand the selected item to show the user other options (for example options 710, 715, 720, 725 etc. as shown in FIG. 7). The user may then set via control button “Timer” 725 how long the vacation activity may last such as 4 days. After setting the “Timer” 725 the user may press album media composition button 710 to activate the media collection feature. The status information “On Vacation” 510A may thus be set and the media communication controller 125 may start collecting and organizing captured media once the user closes the status drawer 405.

Further, the media communication controller 125 may run in the background of the user's device 100 (e.g. smartphone) and configure the processor 105 to begin collecting any media being captured by the device 100, for example as the user begins taking photos or videos using the device camera 145 of the vacation event. The resulting media composition may be captured and organized in real time such as media composition 805 of FIG. 8 on a server (e.g. on server 212A or on 212B as shown in FIG. 2) in a manner that it may be viewed as an album by the user (first user 501 for example) or other users (e.g. second user 601 and other user 502 etc.) over a network as the vacation activity commences. The media communication controller 125 may automatically create the title of the event such as example 802 “On Vacation” from the label of item or status selected from the status drawer 405.

The media communication controller 125 may configure the processor 105 to execute one or more instruction for sending notification to other users, for example, to second user 601, selected to receive the status information of the first user 501 over the network alerting them that new media has been posted to the online album 805 of FIG. 8 which they may view. The status information and the associated media can be continuously shared with the one or more other users, such as second user 601, as long as the timer threshold is met or until the status is deactivated manually by the first user as in step 1254 of FIG. 12. Such Once the timeframe, for example 4 days, has expired as set by control button “Timer” 725 then the media communication controller 125 may instruct the processor to stop collecting media captured by the device 100A and finalize the media composition such as in example shown in FIG. 8 with timeframe 815.

In another embodiment the media communication controller 125 may seek to collect, store, share, group and organize the media composition as an ongoing or continuous arrangement. In a non-limiting example, a user may seek to keep collecting and arrange media such as text, picture, videos, etc. as a part of the same composition in order to journal the progress of an activity, event, person, thing or place of interest which may take place over a longer period of time.

In one embodiment of the invention, the media communication controller 125 may activate this journaling feature, as in step 1242 of FIG. 12, when a selectable item such as but not limited to a control button such as 720 related to the status information 510A or any selectable item is pressed, thus signaling the desire from the user to activate the media journaling feature for the status or item selected. The media communication controller 125 may then detect timer setting, as in step 1246 of FIG. 12, if a timeframe is set through the use of “Timer” button 725, as in step 1244 of FIG. 12. In one embodiment, after activating the feature 720 and setting and sending a status information such as 510A, the media communication controller 125 may make the processor 105 execute instructions to start collecting the acquired media or media played on the device and appearing in the display of the device 100 as in step 1248 of FIG. 12. The media communication controller 125 then instruct the processor 105 to associate the collected media with the selected status information as in step 1250 of FIG. 12. The status information and the associated media can be stored in the device 100 of the first user itself and/or in a device 100 used by another user and/or in a server (e.g. 212A or 212B) as in step 1252 of FIG. 12. The organized media and the status information can be then shared with other users over a network, as in step 1254 of FIG. 12 till the timer threshold is met or till the status information is deactivated/terminated by the first user. The user may pause the journaling of the media by terminating the selected status information or by some other control used to pause the journaling as in step 1306 of FIG. 13.

In any such embodiment, once the status or item is terminated or gets expired, the media journaling may be only paused but not terminated. Once the same item 705 is activated again or set again by the user, as in step 1308 of FIG. 13, the media communication controller 125 may make the processor 105 to continue collecting, sharing with other users over a network, storing and arranging new media captured by the device 100 as a part of the same original media composition for the selected item or status information such as 510A. In this manner new media is continually added to original or prior media arrangement each time the user activates the status information or item and paused each time the status or item 510A is no longer active.

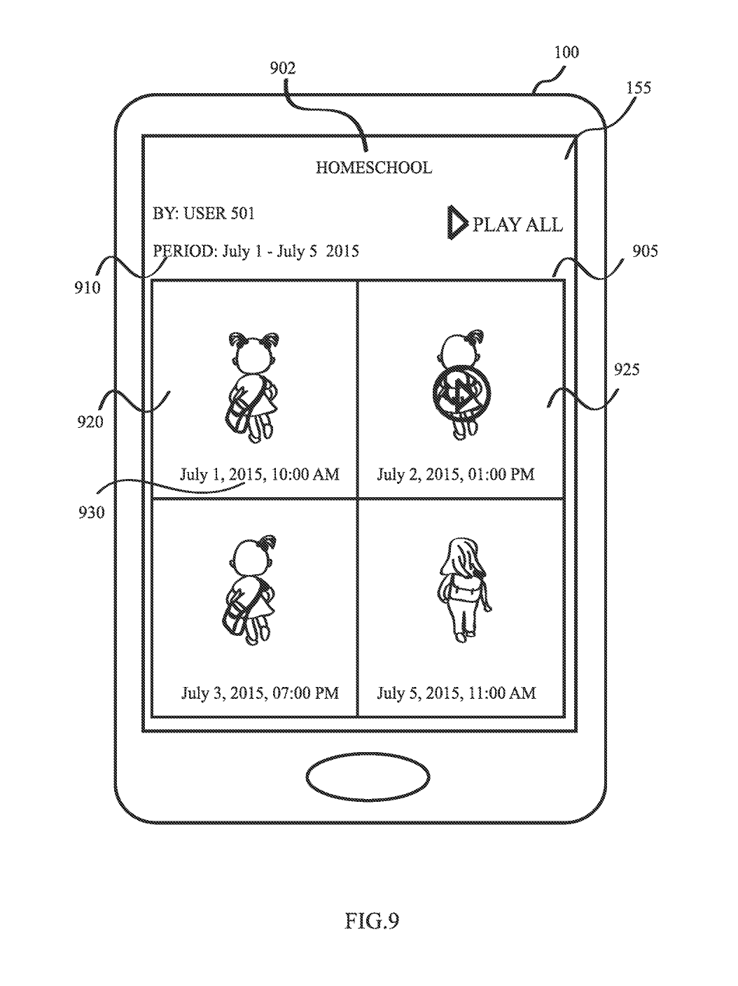

In many embodiments the media journaling feature (control button) 720 may be deactivated or terminated, as in step 1310 of FIG. 13, in order that the media composition such as 905 in FIG. 9 may be finalized, as in step 1312 of FIG. 13, signaling that the journaling of media is completed. To further the embodiment, once the media journaling feature 720 has been deactivated for the selectable item such as but not limited to status information 510A, the media communication controller 125 may no longer add media to the media composition created by feature 720 whenever the status information 510A is active.

In one non-limited embodiment, the user may disable this journaling feature by pressing and holding control button such as 720 or by performing some other action to deactivate the feature. Once the feature 720 has been deactivated, media communication controller 125 may no longer execute instructions to add new media captured from the device 100 to the organized media created by for the selectable item i.e. for status information 510A while feature journaling i.e. control button 720 was active.

In a non-limiting example, as shown in FIG. 9, a user may seek to use pictures and videos to journal the progress of a child's homeschool journey from childhood to adolescence. To this end the user may have installed the media communication controller 125 on her smartphone (i.e. on a device 100). The user may then create or add an item or status information to the status drawer 405 and the user may appropriately name the added/created status information as per his/her wish. For example, the user may name the newly added/created status information as “Homeschool” 902. To continue, the user may begin the media journal by selecting the item “Homeschool” 902 from the status drawer 405 and activate the control button “Journal” 720. Once the item/status information “Home school” 902 has been set, for example by closing the status drawer or by performing some other action to set the item, then any pictures or videos captured by the user's smartphone will be automatically downloaded or uploaded to a specified location on the user's device and/or on a server and organized for viewership in a manner similar to the media composition 905 shown in FIG. 9. The date and timestamp of the captured media may as well be included and the media may be organized in a timeline manner such as shown in FIG. 9.

To continue the example, after the first day of home school, the user may desire to pause creating the media journal 905 so that the user may use their smartphone to capture other media not related to “homeschool”. In this case the user may expire the item or status “Homeschool” 902 by deselecting the status or item 902. After doing so, the user may continue to use their smartphone to capture pictures and videos not related to “homeschool” without this media being captured, stored and organized by the media communication controller 125 installed on the smartphone of the user.

Again, to continue, the next day of homeschool the user may desire to continue the media journaling process, which may be done by again selecting the created “homeschool” item such as 902 from the status drawer 405. After setting item such as item 902 the media communication controller 125 may again instruct the processor 105 to begin collection, storage and organize media captured by the user's smartphone. However, instead of creating a new media composition, the media communication controller 125 may continue adding new media to the original journal media composition and may keep doing so every time the user selects the “Homeschool” item 902 from the status drawer 405 and may pause doing so every time the user deselects item such as 902 or when the item expires. The user may view the child's homeschool progress by viewing the organized journal media composition 905 over a timeline 910 such as in example shown in FIG. 9.

To further continue the example, the user may desire to use the “homeschool” item 902 created in status drawer 405 to only relay the status information to other users over a network such as to relay that the user is busy performing the homeschool activity. In this case the user may or may not want the media communication controller 125 to log the media captured by the device to the journal media composition while the status is active. The media journaling feature 720 may be paused from the item so that user may freely select the “Homeschool” status from the drawer and send this status information to other users such as to relay busyness information without the media communication controller 125 collecting media captured during this time period.

FIG. 8 is an illustration of a non-limiting exemplary method showing the results of media composition options 710 and 720 as explained in FIG. 7. Herein, media such as videos, pictures may be effectively stored, organized in a timeline on a server (e.g. server 212A or server 212B as shown in FIG. 2) for viewership on one or more devices (e.g. device 100B, 100C, 100D etc. as shown in FIG. 3 and FIG. 6) connected to the server over a network. In one embodiment a title such as in example 802 as shown in FIG. 8 is automatically generated when the user selects a status information from the status drawer and when either control buttons 710 or 720 may have been activated.

In the same embodiment the media communication controller 125 may, by default, use the label of selectable item such as example 510A in order to create the title 802 of the organized media composition 805 in the example shown in FIG. 8. In a non-limiting example, both the items i.e. status information 510A of FIG. 7 and title 802 of media composition 805 may be labeled as “On Vacation”. In another embodiment, the user may have the option through the GUI provided by the media communication controller 125 of the present invention to edit the default name of the title 802 without affecting the naming of the selectable item 510A. Yet in another embodiment the name of the title 802 and the label of the selected item/status information 510A may be dynamically linked such that renaming one may effectually rename the other.

In one embodiment, the name of the user 810 capturing the media is made to get uploaded from the device 100 by the media communication controller 125 of the invention to the server (212A and/or 212B for example) and made viewable. In another embodiment, the period in which the first and last media was posted may be viewed such as in example 815.

In the case of album media composition button 710, by means of which an online media album is created, the start and end time of period 815 may only be created after the album media composition is finalized as shown in FIG. 8. Whereas, in the case of control button 720, through which a continuous journaling of the media occurs, the start and end time may be first viewed when at least two media such as 920 and 925 are present in the media composition 905 as shown in FIG. 9. In one embodiment the start date/time may remain fixed while the end date/time may continually change as new media is uploaded to the journal media composition 905. In many embodiments, media uploaded such as 820 or 920 may be date and time stamped such as example 830 or 930 in order that the media may be viewed progressively in a timeline.

In one embodiment, the online media composition 805 may have an option 835 to play the stored media such as, for example, 820, 825, 840 and 845 shown in FIG. 8. In the same embodiment, after activating this feature 835, the media communication controller 125 may make the processor 105 progressively play media included in the media composition 805 one at a time including both pictures and videos. Further, once option 835 becomes active, the invention may also begin playing background audio such as but not limited to music in order to enhance the viewership experience of such media.

In one embodiment, the category of music which may be played may be made relevant to the title 802 of the organized media composition 805 by the media communication controller 125. In another embodiment audio advertisement may be played in the background and, in such case, the media communication controller 125 may only play advertisement relevant to the title 802 of the organized media composition 805.

In one embodiment, while pictures such as example 825, 840 are being viewed, background audio maybe played at a more full volume, whereas in the same embodiment the media communication controller 125 may seek to bring the audio to a lesser volume, while videos such as example 820 are being viewed. In another embodiment the media communication controller 125 may make the processor 105 filter any vocal accompaniment from the background music while media such as videos 820 are being viewed. It is common knowledge that most videos carry sound and dialogue and thus the above mentioned methods may be used such as to create less distraction for users while videos are being viewed.

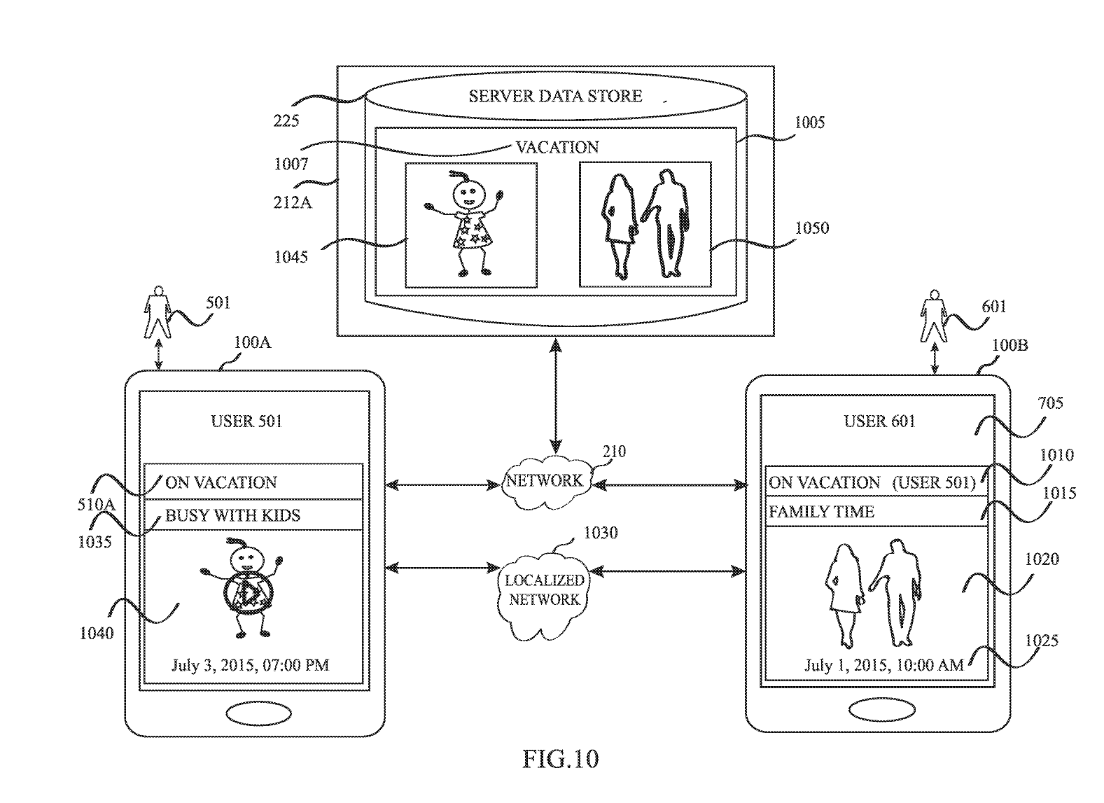

FIG. 10 is an illustration of a non-limiting exemplary method by which media such as videos, pictures, text, etc. may be effectively stored, grouped and organized into a single media composition on a server by 2 or more users with the help of 2 or more devices.

Example in FIG. 10 shows an online media composition 1005 of photos and videos grouped and organized per the invention and located on a server data store 225 at server 212A initiated by a first user 501. The media communication controller 125 installed on one device may communicate with media communication controller 125 installed on other devices to allow more than one users on different devices to contribute to the online media composition such as shown in example of FIG. 10. In one embodiment, device 100A may be a smartphone, tablet, pc, game console, etc. on which a first user 501 may desire to capture and create organized media per the current invention as explained with respect to FIG. 7, FIG. 8 and FIG. 9. First user 501 may also desire that one or more other users such as second user 601 associated with a common selectable item/status information on device 100A such as a vacation status 510A, also contribute to the online media composition 1005 initiated by the first user 501.

In one embodiment, after initiating the media composition first user 501 may send an invitational request to a second user 601 over a network in order that second user 601 may be granted access via the system (e.g. system 200 or system 300 shown in FIG. 2 and FIG. 3) for storing, organizing and sharing media of the present invention to add media to the online media composition 1005.

In another embodiment, second user 601 having access rights to view first user 501 initiated media composition 1005 may send request from device 100B over the network 210 to first user 501 in order to be granted permission to join first user 501 in creating the online media composition 1005 using methods of the invention explained for FIG. 7.

In any such embodiment, upon either party accepting sent request, a selectable item/status information identifying first user 501 and first user 501's activity such as, but not limited to, for example a status labeled “On Vacation” 510A on first user 501's device 100A, may be generated and made accessible on device 100B belonging to second user 601 such as, for example, “Vacation (User 501)” 1010 through the media communication controller 125 also running on device 100B. In one embodiment, the generated item 1010, once selected or activated by second user 601, may engage media communication controller 125 running on device 100B, thus, instruct processor 105 of device 100B, to begin uploading and adding media such as 1020 captured by device 100B, to the organized media composition 1050 initiated by first user 501 for as long as item 1020 is active on user 601's device 100B. In this manner first user 501 and second user 601, utilizing two separate devices (100A and 100B in the present example) may both create a single online media composition 1005 as shown in FIG. 10.

In one embodiment, an online album media composition 805, created through album media composition button 710 such as explained with respect to FIG. 7 and FIG. 8 initiated by first user 501, is produced by both users on separate devices. In another embodiment, an online journal media composition 905, produced through journal media composition button 720 as explained with respect to FIG. 7 and FIG. 9 initiated by first user 501, is produced by both the users on separate devices. In many embodiments, an online album media composition 805 and/or online journal media composition 905, although initiated by one user, may be contributed to by a multiplicity of users on different devices similar to device 100 running the media communication controller 125 of the present invention using the same method described with respect to FIG. 7, FIG. 8, FIG. 9 and FIG. 10.

In another embodiment, reference to FIG. 10, the invention may make use of localized wireless technologies 1030 such as, but limited to, Wi-Fi or Bluetooth and may identify users of the invention that are sharing a localized connection 1030. This identification system may be used to identify that users are in the same proximity and thus may be performing a similar activity (e.g. “At the Zoo”) together. Thus the present invention may make use of this knowledge in order to allow users sharing the localized connection 1030 to quickly perform the steps as explained with respect to FIG. 10.

To continue, a user such as first user 501 may select an item/status information from the status drawer 405 of the present invention such as, but not limited to, “Busy With Kids” 1035 and may or may not activate either album 710 or journal 720 buttons explained in FIG. 7. Another user such as user 601 on a different device 100B but on the same localized connection 1030 (e.g. Wi-Fi) as the first user 501 may also select an item from within the status drawer such as “Family Time” 1015 and may or may not activate the media composition feature 710 or 720 as explained with respect to FIG. 7. Once the media communication controller 125 detects the above events, it may automatically issue commands to the processor 105 to create a single online media composition 1005 on a server 212A from both users' devices with or without attaining permissions from both users to do so.

In another embodiment, the proximity of users running the media communication controller 125 may be determined by use of position device 165 e.g. GPS system running on devices and, thus, the same process as described above may be achieved.

In one embodiment, reference to FIG. 10, the title 1007 of the shared online media composition 1005 may be edited by either first user 501 or second user 601 and may be viewed separately by each user. For example, first user 501 may title the shared media composition 1005 as “Mark's Vacation” and the second user 601 may title the composition 1005 as “Rachel's Vacation”, and, so, the shared media composition 1005 may take on a multiplicity of titles viewable by each user titling or renaming the media composition respectively. In a similar manner, media such as example 1045 and 1050 may be edited, for example: deleted, made hidden, renamed, etc. in an individual manner and, thus, the content of the media composition 1005 although initially the same for both users, may differ over time.

In another embodiment, a multiplicity of the same media composition 1005 may exist at multiple locations on server 212A, each belonging to different users. Thus, each user, although having the same content such as media composition 1005, may contain it at individual locations on server 212A and may edit the content individually in this manner.

In one non-limiting embodiment the invention, reference to FIG. 10, the media communication controller 125 may identify users of the present invention over the localized network 930 via user accounts. In another embodiment, devices using the invention may be identified over the localized network 930. In many non-limiting embodiments, both user accounts and device ID may be identified over localized network 930.

To further make clear the present invention, reference to FIG. 7 and FIG. 10, first user 501 and second user 601, both having smartphones (i.e. device 100) with the media communication controller 125 installed may be on vacation and may want to create an online album media composition from pictures and videos captured by both user's devices while on the vacation event. First user 501 may activate feature “Album” 710 from inside status information 510A “On Vacation” on device 501 as well as set the status so that any pictures or videos such as example 1040 taken by device 100A may be automatically uploaded to the shared vacation album media composition 1005 on the cloud server 212A which was automatically setup when first user 501 activated album media composition button 710. In addition, first user 501 may then send an invitational request to second user 601 to join the album media composition process. Upon second user 601 accepting the request from first user 501, first user 501's “on vacation” status 510A may be automatically generated and made accessible on second user 601's device 100B as shown in example 1010 in FIG. 10. After second user 601 activates “Vacation (User 1)” status 1010, pictures or videos taken by device 100B such as example 1020 may be automatically uploaded to the vacation album media composition 1005 and may be arranged in a timeline under the vacation category for as long as the vacation status 510A is set by first user 501. Option to pause/resume the album creation process while on vacation may be made selectable on device 100A and device 100B so that both first user 501 and second user 601 may pause or resume the album media composition process during vacation event. Upon the status 510A expiring on first user 501's device 100A such as by timer 725 or by other methods described with respect to FIG. 7, online shared media composition 1005 may be finalized and item 1010 removed from the second user 601's device 100B.

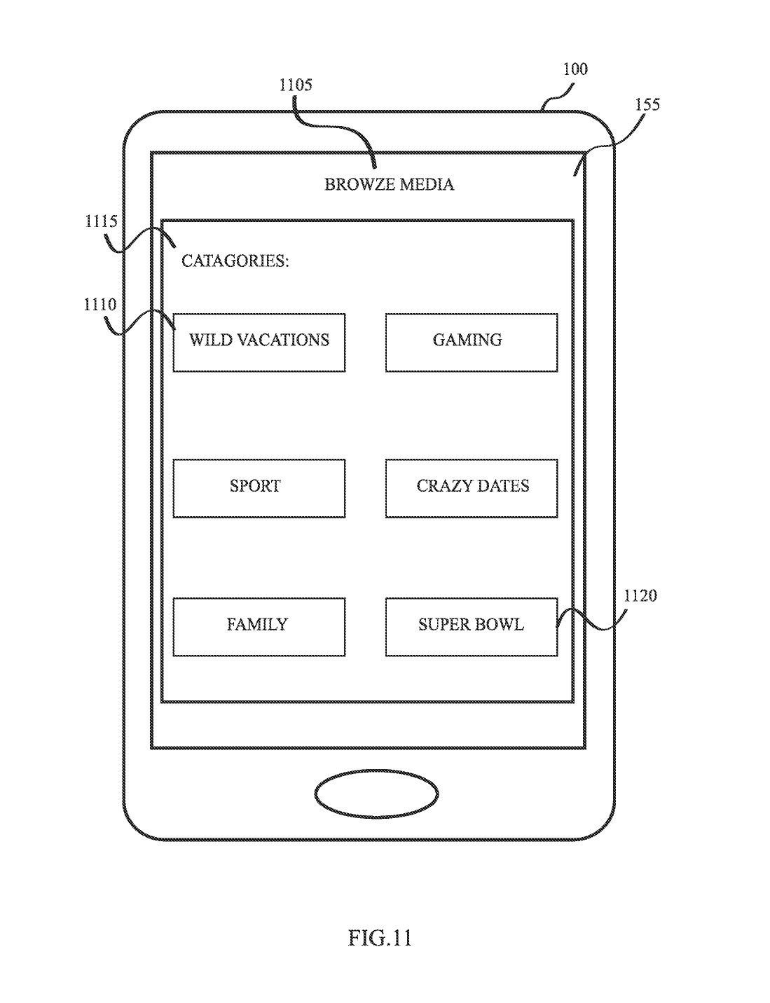

FIG. 11 is an illustration of a non-limiting exemplary method showing how the invention may automatically place the media compositions such as example 805 of FIG. 8 or 905 of FIG. 9 into various categories on a server (212A or 212B for example). Herein, media such as videos, pictures may be effectively stored, grouped and organized such as in example 805 of FIG. 8 under categories such as example 1115 of FIG. 11.

In one embodiment, categories 1115 such as example 1110 shown in FIG. 11 may be automatically created and associated with selectable items such as status information 510A in example shown in FIG. 7. For example, upon creating a selectable item/status information through the invention such as “On vacation” 510A, a category “On Vacation” may be effectually and automatically created online for the status. Thus any media or media compositions associated with the status 510A may be stored under the created category.

In another embodiment, selectable items such as but not limited to an “On Vacation” status information 510A may come preloaded with the media communication controller 125 of the present invention and associated categories 1115 created online such as example 1110 “Wild Vacations”. Thus, a multiplicity of media captured by means of the devices 100 with media communication controller 125 installed, and such captured media being associated with a selected status information such as “On Vacation” 510A, may be automatically grouped such as in example media composition 805 shown in FIG. 8 and may be organized under a category such as in example 1110 “Wild Vacations” as shown in FIG. 11 as long selection “On Vacation” 510A remains active.

In another embodiment, categories 1115 may be created from a multiplicity of devices 100 involving multiple users by use of a prevalent identification system in which the media communication controller 125 queries the naming of the selectable items such as status 510A as created by users and tries to identify or establish a popular theme. For example, a multiplicity of users may have created a status 510A labeled “On vacation” or similar. In the same embodiment, after x amount of users such as for example 100,000 users have created the same or similar selectable items such as “On Vacation” 510A, a category such as example 1110 “Wild Vacations” may be automatically created online and may be automatically linked to the status 510A and all other similar variations of item/status/status information 510A created by other users of the system of the present invention. In many embodiments, the linking may automatically occur with or without any authorization from users. Thus the invention may organize media by allowing users to post particular media of interest which may or may not be associated with selectable items such as item 510A under the created category online 1110 in order that a multiplicity of users having interest in such category of media may browse media 1105 created by a multiplicity of users under the category of interest.

In all embodiments depicted in this document the word button in its usage may depict a virtual button such as displayed on a touch screen device but in no way limits the scope of the invention. Other applications may include physical buttons, controls, knobs or other virtual or physical or non-virtual mechanisms for executing different functions provided through the present invention.

In some embodiments, embodiment software may import data from external platforms. In a non-limiting example, software may import social media contacts from Facebook, Yahoo, etc. Some embodiments may allow users to add and/or invite other users. In a non-limiting example, users may add and/or invite imported contacts to become part of users' network. In some embodiments, software may be suitable for detecting various media data, including, without limitation, audio data, video data, textual data, data from a game, film, website etc. In some of these embodiments, software may be suitable for sampling and/or processing of detected data. In a non-limiting example, software may process media data to determine whether user may be performing certain actions such as, without limitation, playing video games, listening to music, watching videos, etc. In another non-limiting example software may process media data to determine information about the media such as name of the media and other pertinent information about the media. In a non-limiting example, software may initialize a status drawer from within or outside messenger application in response to camera activity detection. In another non-limiting example, software may preload the status drawer with data associated with the media detected. In yet another non-limiting example, the software may issue a prompt to the user to manually select a status from the status drawer. In some embodiments, software may perform continuous and/or repeated processing of media data. In one or more embodiment, software may stop all related status notifications upon detection that the media is no longer active, such as the user is no longer listening to a particular song, watching a particular movie or listening to music or watching videos in general.

In some embodiments, media detection software may run in background of a device. In one or more embodiments, media detection software may provide high efficiency. In a non-limiting example, detection software may not run if device screen may be off and/or locked. In some embodiments, media detection software may employ a variety of mechanisms.

In some embodiments, an “application” may be any software program, including, without limitation, a chat application, Social Media Networking application, or other media application. In some of these embodiments, application may check user network status. In a non-limiting example, application may determine if members of user's network are online. In some embodiments, network information may be populated in device notification system, and user may check status as with other notifications. In at least one embodiment, user may check messages from others through notification service.

In other embodiments, an application may be able to run in a standalone mode, in which user may access any functionalities of an application in a device foreground. In some of these embodiments, software may be suitable to perform a variety of functions, including, without limitation: accessing application settings; sending standard texts (not using singular mode stacked messaging); recording, uploading, and/or sending photos; recording, uploading, and/or sending video text; performing live video chat; performing audio only chat; searching for users in a database; and inviting users from a database.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing processing of media data according to the present invention will be apparent to those skilled in the art. Various aspects of the invention have been described above by way of illustration, and the specific embodiments disclosed are not intended to limit the invention to the particular forms disclosed. The particular implementation of the processing of media data may vary depending upon the particular context or application. By way of example, and not limitation, the processing of media data described in the foregoing were principally directed to audio implementations; however, similar techniques may instead be applied to video, text, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method for managing media associated with a user status through a device, said method being executed by one or more processors configured by a media communication controller operably installed in said device to perform one or more operations comprising:
providing a status drawer having a plurality of selectable status information on a graphical user interface on said device;
displaying one or more media acquired by said device on one or more windows provided inside said status drawer;
detecting selection of a status information from said plurality of selectable status information;
collecting said displayed one or more media locally on said device or on a server over a network;
associating said collected one or more media with said selected status information; and
creating a media composition comprising said associated one or more media.

2. The method as in claim 1, wherein said media communication controller runs in the background of said device and, on detection of said one or more media acquisition, activates said status drawer for enabling said media composition.

3. The method as in claim 1, wherein said media acquisition is done through a third party application running on said device.

4. The method as in claim 1, wherein said selected status information and said created media composition associated with said selected status information are shareable over said network by a first user with one or more other users.

5. The method as in claim 4, wherein said shareable media composition are contributable by both said first user and said one or more other users.

6. The method as in claim 1, wherein said one or more media acquired by said device are a video or an image captured through a camera or downloaded to said device, an audio captured through a microphone or downloaded to said device and a text being typed or media downloaded to said device.

7. The method as in claim 1, wherein said status drawer provides one or more control buttons as recording options for said one or more media acquisition.

8. The method as in claim 1, wherein said media composition is continued till the time said selected status information remains active.

9. The method as in claim 1, wherein said status information includes a status, an item, an activity, an event, a person, a thing and a place of interest.

10. The method as in claim 1, wherein a handle with a visual alert is provided with said status drawer.

11. The method as in claim 1, wherein a media window icon displaying said one or more media acquired are provided with one or more of said plurality of selectable status information.

12. The method as in claim 1, wherein said media composition is organized as an album media composition.

13. The method as in claim 1, wherein said collecting of said one or more media occurs continuously over a period of time with temporary pause or deactivation of said selected status information in between to produce said media composition organized as a journal media composition.

14. A device for managing media associated with a user status, said device comprising:
one or more processors;
one or more media acquiring devices for acquiring one or more media; and
a device memory storing a media communication controller;
wherein one or more computer readable instructions included in said media communication controller executed by said one or more processors cause the device to, at least:
provide a status drawer having a plurality of selectable status information on a graphical user interface on said device;
display said acquired one or more media on one or more windows provided inside said status drawer;
detect selection of a status information from said plurality of selectable status information;
collect said displayed one or more media locally on said device or on a server communicatively coupled to said device over a network;
associate said collected one or more media with said selected status information; and
create a media composition comprising said associated one or more media.

15. The device as in claim 14, wherein said media communication controller runs in the background of said device and, on detection of said one or more media acquisition, activates said status drawer for enabling said media composition.

16. The device as in claim 14, wherein said selected status information and said created media composition associated with said selected status information are shareable over said network by a first user with one or more other users.

17. The device as in claim 14, wherein said status drawer provides a plurality of media capture options, including an album option and a journal option for any given status selection, which are selectable for creating said media composition.

18. The device as in claim 17, wherein said collecting of said one or more media occurs continuously over a period of time with temporary pause or deactivation of said selected status information in between to produce said media composition organized as a journal media composition on said selection of said journal option.

19. The device as in claim 14, wherein a media window icon displaying said one or more media acquired are provided with each of said plurality of selectable status information.

20. A non-transitory computer readable storage medium storing a media communication controller having one or more computer programming logic that, when executed on one or more processors included in a device, for managing media associated with a user status, causes said device to, at least:
provide a status drawer having a plurality of selectable status information on a graphical user interface on said device;
display said acquired one or more media on one or more windows provided inside said status drawer;
detect selection of a status information from said plurality of selectable status information;
collect said displayed one or more media locally on said device or on a server communicatively coupled to said device over a network;
associate said collected one or more media with said selected status information; and
create a media composition comprising said associated one or more media.
